(19) United States
(12) Patent Application Publication
(10) Pub. No.: US 2004/0103057 A1
(43) Pub. Date: May 27, 2004

(54) System and method for processing a long distance communication using a debit account

(75) Inventors: James B. Melbert, Spring, TX (US); Paul Friedberg, Spartanburg, SC (US)

Correspondence Address: Baker Botts L.L.P., Suite 600, 2001 Ross Avenue, Dallas, TX, 75201-2980, US

(73) Assignee: WorldPass Corporation

(21) Appl. No.: 10/304,932

(22) Filed: Nov. 26, 2002

(51) Int. Cl. G06F 17/60

(52) U.S. Cl. 705/38

(57) ABSTRACT

A method for processing a long distance communication using a debit account comprises receiving a deposit into a debit account, the account identified by an account identifier and the account comprising a balance, and updating the balance of the account. A first request for balance verification is received from a long distance provider in response to the long distance provider receiving an attempt to make a long distance communication using the debit account. The first request comprises a first amount and the account identifier. A first verification is communicated to the long distance provider. The first verification comprises the account identifier. A second request for balance verification is received from a debit card network provider in response to the debit card network provider receiving an attempt to withdraw funds from the debit account. The second request comprises a second amount and the account identifier. A second verification is communicated to the debit card network provider. The second verification comprises the account identifier.

### TECHNICAL FIELD OF THE INVENTION

This invention relates generally to telecommunications and, more specifically, to processing a long distance communication using a debit account.

### BACKGROUND OF THE INVENTION

Debit account systems provide account holders near immediate access to account balances through debit card network providers such as Star, Pulse, Cirrus, and Maestro. Traditionally these debit account systems do not allow debit account holders to charge a long distance communication using the debit account. For example, many conventional debit account systems require a four-digit PIN to withdraw funds from the debit account. These traditional systems prohibit the transmission of the four-digit PIN across a POTS (Plain Old Telephone System) because it may compromise the security of the PIN, thereby prohibiting the debit account holder from charging the long distance communication to the debit account.

### SUMMARY OF THE INVENTION

In accordance with the present invention, the disadvantages and problems associated with debit account systems have been substantially reduced or eliminated.

In one embodiment, a method for processing a long distance communication using a debit account comprises receiving a deposit into a debit account, the account identified by an account identifier and the account comprising a balance, and updating the balance of the account. A first request for balance verification is received from a long distance provider in response to the long distance provider receiving an attempt to make a long distance communication using the debit account. The first request comprises a first amount and the account identifier. A first verification is communicated to the long distance provider. The first verification comprises the account identifier. A second request for balance verification is received from a debit card network provider in response to the debit card network provider receiving an attempt to withdraw funds from the debit account. The second request comprises a second amount and the account identifier. A second verification is communicated to the debit card network provider. The second verification comprises the account identifier.

### BRIEF DESCRIPTION OF THE DRAWINGS

For a more complete understanding of the present invention and its advantages, reference is now made to the following descriptions, taken in conjunction with the accompanying drawings, in which:

FIG. 1 illustrates one embodiment of a system for processing a long distance communication using a debit account;

FIG. 2 illustrates a debit account table in accordance with the system of FIG. 1; and

FIG. 3 is a flow chart illustrating one embodiment of a method for processing a long distance communication using a debit account.

### DETAILED DESCRIPTION OF EXAMPLE EMBODIMENTS OF THE INVENTION

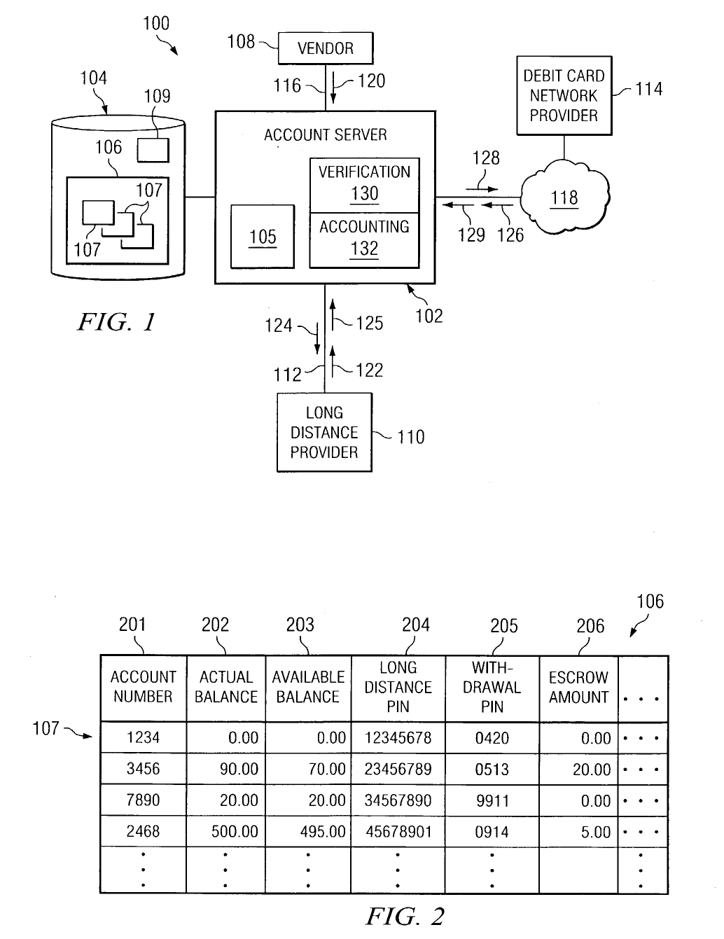

FIG. 1 illustrates one embodiment of a system 100 for processing a long distance communication using a debit account. System 100 includes account server 102, vendor 108, long distance provider 110, and debit card network provider 114. In general, system 100 allows a debit account holder to withdraw funds through debit card network provider 114 and charge a long distance communication through long distance provider 110 using the same debit account.

Account server 102 processes the debit accounts and comprises an electronic computing device operable to receive, transmit, process and store data associated with system 100. For example, server 102 may comprise a general-purpose personal computer (PC), a Macintosh, a workstation, a Unix-based computer, a server computer, or any other suitable device. Account server 102 communicates with long distance provider 110, debit card provider 114, or vendor 108. For example, account server 102 may communicate with vendor 108 over dedicated line 116, communicate with long distance provider 110 over dedicated line or POTS 112 and communicate with debit card network provider 114 over debit card network 118. One or more modules of system 100 may be included in the same computing device. For example, vendor 108 and debit card network provider 114 may be different modules in one device operable to receive and disburse funds.

Account server 102 includes memory 104, processor 105, verification module 130, and accounting module 132. In one embodiment, verification module 130 and accounting module 132 comprise software applications that may be stored in memory 104 and executed by processor 105. Although FIG. 1 only provides one example of a server that may be used with the invention, system 100 can be implemented using computers other than servers as well as a server pool.

Memory 104 may include any memory or database module and may take the form of volatile or non-volatile memory including, without limitation, magnetic media, optical media, random access memory (RAM), read-only memory (ROM), removable media, or any other suitable local or remote memory component. In this embodiment, memory 104 includes debit account table 106, which comprises debit account records 107, described in more detail in FIG. 2. Each debit record 107 includes a number of debit account characteristics such as, for example, an account identifier, an actual and available balance 202 and 203, and two PINS 204 and 205. As illustrated in FIG. 2, each debit account may be stored in a separate debit account record 107 in memory 104. Memory 104 may include any other data such as, for example, an invoice table for long distance providers 110 or an account table for vendors 108.

Processor 105 executes instructions and manipulates data to perform the operations of account server 102. Although FIG. 1 illustrates a single processor 105 in account server 102, multiple processors 105 may be used according to particular needs, and reference to processor 105 is meant to include multiple processors 105 where applicable. In the illustrated embodiment, processor 105 executes verification module 130 and accounting module 132.

Verification module 130 processes verifications of debit account balances for long distance providers 110 and debit card network providers 114. Accounting module 132 maintains debit account table 106 in response to communications from vendor 108, long distance provider 110, and debt card network provider 114. It should be understood by those skilled in the art that verification module 130 and/or accounting module 132 may reside locally in memory 104 or remotely on another computer server. It will be further understood that while verification module 130 and accounting module 132 are illustrated as multiple modules, the features and functionalities performed by these modules may be performed by a single multi-tasked module. Verification module 130 and accounting module 132 may be any software or logic operable to process a long distance communication using the debit account. Verification module 130 and accounting module 132 may be written in any appropriate computer language such as, for example, C, C++, Java, Pascal, and others.

Vendor 108 may be a server, a computer, a workstation, an automated teller machine, a card reader, or any other type of device that can suitably communicate a deposit 120 to account server 102. Generally, vendor 108 receives a deposit from a debit account holder and, in response, communicates deposit 120 into the appropriate debit account. The communication of deposit 120 from vendor 108 to account server 102 may happen in at least two ways. First, vendor 108 may comprise a card reader that allows the debit account holder to swipe a debit card containing the debit account identifier. In this example, the card reader would accept the deposit amount and communicate deposit 120 to account server 102 via a modem or TCP/IP connection, illustrated as dedicated line 116.

A second example technique of vendor 108 depositing funds might involve account server 102 maintaining vendor account records 109. Each record includes a vendor identifier and links to one or more debit account records 107. This would allow vendor 108 to accept a number of deposits from different debit account holders and communicate a combined deposit 120 to account server 102. In this example, dedicated line 116 may not be directly coupled to account server 102, but instead coupled to debit card network 118. Accordingly, vendor 108 receives a plurality of deposits from one or more debit account holders. Vendor 108 then communicates one deposit 120 through debit card network 118. Deposit 120 may include the terminal ID, a vendor identifier to locate the appropriate vendor account record, and one or more deposit amounts. Using the located vendor account record, account server 102 then updates the appropriate debit account records 107 using information from the vendor account record.

Long distance provider 110 may include any server, computer, terminal, voice response system (VRS), or any other device that can process an attempt by the debit account holder to make a long distance communication using the debit account stored on account server 102. According to particular embodiments, long distance provider 100 is a long distance telephone company such as, for example, AT&T, Verizon, MCI, or Sprint. Long distance provider 110 is coupled to account server 102 via dedicated line 112. It will be understood that dedicated line 112 may be a POTS connection, a TCP/IP connection, a dial-up connection, a VPN session, or any other connection that is able to securely communicate the debit account information.

Debit card network provider 114 may include any server, computer, terminal, automated teller machine (ATM), financial institution, or any other device operable to disburse funds from a debit account. In general, debit card network provider 114 disburses funds from the appropriate debit account stored on account server 102 to the debit account holder via debit card network 118. For example, debit card network provider 114 may be Star™ or Pulse™. Debit card network 118 may include any worldwide or local ATM network operable to securely couple debit card network provider 114 to account server 102.

In one aspect of operation, a debit account holder initially funds his debit account, stored on account server 102, through deposits with vendor 108. Vendor 108 processes the deposit from the debit account holder and communicates deposit 120 to account server 102 to update the appropriate debit account. It will be understood that the deposit that vendor 108 receives from the debit account holder may comprise a first deposit and deposit 120 communicated to account server 102 may comprise a second deposit. Moreover, vendor 108 may subtract a service charge from the first deposit resulting in the second deposit being less than the first deposit. In one embodiment, deposit 120 includes an account identifier, a terminal ID, and a deposit amount.

Account server 102 receives deposit 120 from vendor 108 via dedicated line 116 and updates the appropriate debit accounts. As described above, account server 102 may also receive deposit 120 via debit card network 118. Accounting module 132 locates the appropriate debit account record 107 based, at least in part, on the account identifier from deposit 120. In one embodiment, accounting module 132 may use the account identifier as a key into debit account table 106. If accounting module 132 is unable to locate the appropriate debit account record 107, accounting module 132 may create a new debit account record 107 based on deposit 120. In this circumstance, accounting module 132 may initialize the new account record 107 and load the account identifier from deposit 120. Next, accounting module 132 updates the one or more balances in debit account record 107 based upon the deposit amount from deposit 120. Once the debit account balances have been updated based on deposit 120, the debit account holder can perform other transactions using the debit account including charging a long distance communication and withdrawing the deposited funds.

The debit account holder may initiate a long distance communication through long distance provider 110 using his debit account. This may include the debit account holder giving long distance provider 110 the account identifier and long distance PIN for his debit account and the information regarding the recipient of the long distance communication, such as a telephone number. For example, the debit account holder may call long distance provider 110 to charge a long distance phone call using his debit account. Through interactions with long distance provider 110, the debit account holder enters his debit account identifier, long distance PIN, and the phone number. Long distance provider 110 processes the input from the debit account holder and sends a long distance request 122 to account server 102 in order to verify that the caller has a sufficient balance in the associated debit account to make the call.

Long distance provider 110 communicates request 122 to account server 102 in order to receive an account verification in response to the attempt by the debit account holder to make the long distance communication. Request 122 may include the entered account identifier, long distance PIN, and a long distance transaction amount. The transaction amount may comprise any amount deemed appropriate by long distance provider 110 or the debit account holder to complete the call. Once account server 102 receives request 122, verification module 130 locates the appropriate debit account record 107 based, at least in part, on the account identifier from request 122. Verification module ensures that the long distance PIN from request 122 and long distance PIN 204 from the debit account record 107 match. If identical, then verification module 130 ensures that the debit account holder has enough funds to cover the transaction amount. Verification module compares the available balance 203 from debit account record 107 to the transaction amount from request 122. Based upon these exemplary comparisons, verification module 130 computes a verified amount. If the transaction amount is more than available balance 203, then the verified amount may be less than the transaction amount and equal to the available balance 203. Otherwise, the verified amount may equal the transaction amount. Accounting module 132 stores the verified amount as an escrow amount 206 and reduces the available balance 203 in debit account record 107 by the escrow amount 206. The escrow amount 206 may represent a difference between the actual balance 202 and the available balance 203 in the debit account. This allows the debit card holder to use the debit account for multiple transactions, while ensuring that there are enough funds available for these transactions. Once a transaction is complete, the remaining escrow balance is returned to available balance 203.

After processing request 122, account server 102 sends either an approval or a rejection to long distance provider 110. In one embodiment, account server 102 communicates a verification 124 to long distance provider 110. Verification 124 may include an account identifier, either a positive or negative verification, and the verified amount. In response to a positive verification 124, long distance provider 110 allows the debit account holder to initiate the requested long distance communication. Long distance provider 110 may limit the time of the long distance communication based on the verified amount divided by a long distance rate. Once the verified amount is reached by the length of the long distance communication, long distance provider 110 may send further requests 122 to account server 102 for additional verified amounts to extend the communication. Account server 102 processes the additional requests 122 similarly to that described above. Alternatively, long distance provider 110 may terminate the call.

In response to a negative verification 124, which means that the account information did not match or that there are no available funds, long distance provider 110 prohibits the debit account holder from making the long distance communication or, in the case of an ongoing communication, long distance provider 110 terminates the communication. The long distance communication may also be terminated by the debit account holder, for example, by hanging up a telephone or disconnecting a modem session. Once the long distance communication is terminated, long distance provider 110 communicates a long distance invoice 125 to account server 102. Invoice 125 may include an account identifier and a long distance invoiced amount. Long distance provider 110 may calculate the invoiced amount based on the time of the long distance communication multiplied by the long distance rate. Account server 102 receives invoice 125 and locates the appropriate debit account record 107 based on the account identifier from invoice 125. Accounting module 132 reduces the actual balance 202 and available balance 203 in the debit account record 107 based, at least in part, on the invoiced amount for the long distance communication using the debit account.

Using the same debit account utilized in the long distance communication, the debit account holder may also withdraw funds from debit card network provider 114. For example, the debit account holder may swipe a debit card, containing the debit account identifier, and enter a withdrawal PIN at an ATM to withdraw money from his debit account. Debit card network provider 114 processes the input and sends a request 126 to account server 102 to verify the input. Debit card network provider 114 communicates a request 126 to account server 102 via debit card network 118. Request 126 may include a terminal ID, account identifier, withdrawal PIN, withdrawal transaction amount, or any other information suitable to verify the balance of the appropriate debit account. As described above, the withdrawal PIN may comprise a 4 digit PIN that is distinguishable from the long distance PIN.

Account server 102 receives request 126, from debit card network provider 114, and verifies the debit account information. It will be understood that account server 102 may process request 122 (long distance communication) and request 126 (funds withdrawal) at substantially the same time. Verification module 130 locates the appropriate debit account record 107 based, at least in part, on the account identifier from request 126. Verification module verifies that the withdrawal PIN from request 126 and the withdrawal PIN from the debit account record 107 are identical. Verification module 130 compares the available balance 203 from the located account record 107 to the transaction amount from request 126. As discussed above, the available balance 203 may be modified by an escrow amount 206 associated with a long distance communication. Based upon this comparison, verification module 130 communicates a verification 128 to debit card network provider 114. Verification 128 may include the account identifier, a positive or negative verification, and a verified amount.

Based on verification 128, debit card network provider 114 may disburse funds to the debit account holder. Once the transaction is complete, debit card network provider 114 may send an invoice 129 to account server 102. Invoice 129 may include an account identifier and a withdrawal invoiced amount. Debit card network provider 114 may compute the invoiced amount to include the verified amount from verification 128 plus a surcharge. Account server 102 receives invoice 129 and locates the appropriate debit account record 107 based on the account identifier from invoice 129. Accounting module 132 reduces the actual balance 202 and available balance 203 in the debit account record 107 based, at least in part, on the invoiced amount for the funds withdrawal using the debit account represented in debit account table 106.

FIG. 2 illustrates debit account table 106 in accordance with the system 100. In general, system 100 uses debit account table 106 to securely store and process debit accounts. Debit account table 106 may be of any suitable format including XML tables, flat files, comma-separated-value (CSV) files, SQL tables, relational database tables, and others. In one embodiment, debit account table 106 is a multidimensional data structure that includes at least one debit account record 107. Each debit account record 107 logically represents one debit account and includes multiple columns. In this example, debit account record 107 includes an account identifier 201, two personal identification numbers (PINs) 204 and 205, escrow amount 206, and one or more balance columns, including an actual balance 202 and an available balance 203. According to particular embodiments, long distance PIN 204 may comprises a five-digit PIN and withdrawal PIN 205 may comprise a four-digit PIN. It should be noted that debit account record 107 may be accessed by account identifier 201, long distance PIN 204, or any other field. It will be understood that each debit account record 107 may include none, some, or all of the example columns.

System 10 contemplates any other suitable logic to allow for suitable and secure processing of debit accounts. In one embodiment debit account table 106 may also include links to another table, such as, for example, a historical transactions table (not shown). Moreover, debit account table 106 may be separated into multiple tables or logically represented by software data structures without departing from the scope of the invention.

The example debit account records 107 shown in debit account table 106 are “1234”, “3456”, “7890”, and “2468”. Debit account records 107 illustrated in debit account table 106 are merely exemplary. Applying one example record to the exemplary operation of FIG. 1, debit account holder, with account identifier “3456”, deposits $105 with vendor 108. Vendor 108 deducts a $5 service charge, for example, and communicates deposit 120 for $100 to account server 102. Accounting module 132 locates debit account record 107 using account identifier “3456” and adds $100 to actual balance 202 (currently $0) and available balance 203 (currently $0).

Debit account holder “3456” attempts to make a long distance communication through long distance provider 110 by entering his debit account information. Long distance provider 110 communicates request 122, including account identifier “3456”, long distance PIN “23456789”, and long distance transaction amount $20, to accounting server 102. Verification module 130 locates the appropriate debit account record 107 using account identifier “3456”. Verification module 130 verifies the long distance PIN and compares the transaction amount ($20) to available balance 203 ($100) and communicates a positive verification 124 ($20) to long distance provider 110 and account module 132. Accounting module 132 then stores the verified amount ($20) as an escrow amount 206 and reduces the available balance 203 by the escrow amount 206, resulting in an updated available balance 203 (now $80).

Long distance provider 110 communicates invoice 125, including account identifier “3456” and invoice amount $15, to accounting server 102, based on the length of the long distance communication. Accounting module 132 locates the appropriate debit account record 107 using account identifier “3456”. Accounting module 132 then subtracts the invoice amount ($15) from the escrow amount 206 ($20). The difference ($5) is then added to available balance 203 ($80) to determine a new available balance 203 (now $85). Accounting module then subtracts the invoice amount ($15) from actual balance 202 ($100) to determine a new actual balance 202 (now $85).

The debit account holder, with account identifier “3456”, attempts to withdraw funds through debit card network provider 114 using his debit account. In this example, the debit account holder attempts to withdraw $10 before the long distance communication has terminated; therefore, as described above, the current available balance 203 is $80. Debit card network provider 114 communicates request 126, including account identifier “3456”, withdrawal PIN “0513”, and withdrawal transaction amount ($10) to accounting server 102. Verification module 130 locates the appropriate debit account record 107 using account identifier “3456”. Verification module 130 verifies the withdrawal PIN and compares the transaction amount ($10) to available balance 203 ($80) and communicates a positive verification 128 to debit card network provider 114 and account module 132. Accounting module 132 then reduces actual balance 202 ($100) and available balance 203 ($80) by the verified amount to $90 and $70, respectively.

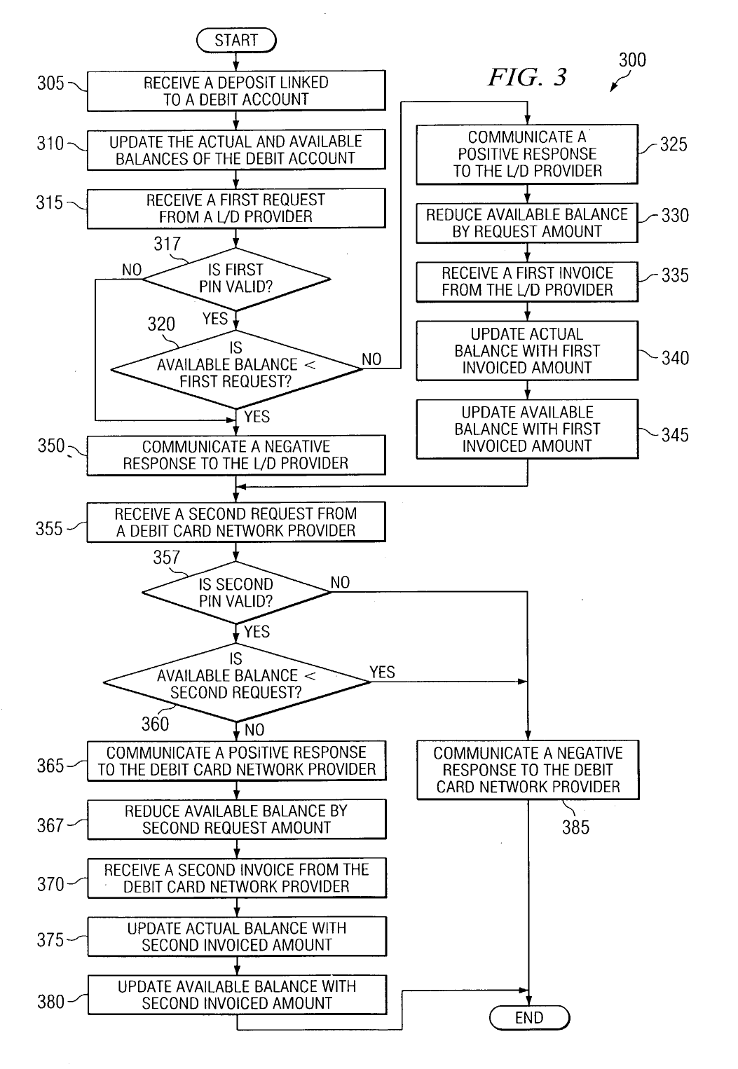

FIG. 3 is a flow chart illustrating a method 300 for processing a long distance communication using a debit account. Method 300 is described in respect to system 100. However, any other suitable system may use method 300 to process a long distance communication using the debit account without departing from the scope of this disclosure.

Account server 102 receives a deposit 120 from vendor 108 that is linked to a debit account at step 305. Once received, accounting module 132 may update the appropriate debit account record 107 in debit account table 106 based upon received deposit 120 at step 310. For example, accounting module 132 may update actual balance 202 and available balance 203 of the appropriate account record 107. At step 315, account server 102 receives a request 122 from a long distance provider 110, in response to an attempt to place a long distance communication by a debit account holder. Execution proceeds to steps 317 through 350 where verification module 130 verifies request 122 from long distance provider 110.

Verification module 130 compares long distance PIN from request 122 with long distance PIN 204 at decisional step 317. If the PINS do not match, then verification module 130 communicates a negative verification 124 to long distance provider 110 at step 350 and the request processing ends. Otherwise, execution proceeds to step 320. At decisional step 320, verification module 130 compares available balance 203 from account record 107 to the request 122. If available balance 203 is not less than request 122, then verification module 130 communicates a positive verification 124 to long distance provider 110. It will be understood that verification module 130 may also communicate the verification 124 to accounting module 132. At step 330, accounting module 132 reduces available balance 203 by the transaction amount. The difference between available balance 203 and the actual balance 202 may comprise the escrow amount 206.

Execution proceeds to step 335, where account server 102 receives an invoice 125 from long distance provider 110. As described above, invoice 125 may include the account identifier and a long distance invoice amount. Accounting module 132 then updates actual balance 202 stored in account record 107 based on the invoice amount at step 340 and updates available balance 203 based on the invoice amount at step 345. Returning to decisional step 320, if available balance 203 is less than the transaction amount, then verification module 130 communicates a negative verification 124 to long distance provider 110 at step 350. Execution then proceeds to step 355.

At step 355, account server 102 receives a withdrawal request 126 from debit card network provider 114, in response to an attempt to withdraw funds by an account holder. Verification module 130 compares withdrawal PIN from request 126 with withdrawal PIN 205 at decisional step 357. If the PINS do not match, then verification module 130 communicates a negative verification 128 to debit card network provider 114 at step 385 and the request processing ends. Otherwise, execution proceeds to step 360. At decisional step 360, verification module 130 determines whether available balance 203 stored in the appropriate account record 107 is less than the transaction amount. If available balance 203 is less than the transaction amount, then verification module 130 communicates a negative verification 128 to debit card network provider 114 at step 385 and the request processing ends. Otherwise, if available balance 203 is not less than the transaction amount at decisional step 360, then verification module 130 communicates a positive verification 128 to debit card network provider 114 at step 365. At step 367, accounting module 132 reduces available balance 203 by the transaction amount. At step 370, account server 102 receives a withdrawal invoice 129 from debit card network provider 114. As described above, invoice 129 may include the account identifier and a withdrawal invoice amount. Accounting module 132 updates actual balance 202 stored in account record 107 with the invoiced amount at step 375 and updates available balance 203 with the invoiced amount at step 380.

The preceding flow chart and accompanying description illustrate only an exemplary method for account server 102 to process long distance communications using a debit account 107. However, system 100 contemplates account server 102 using any suitable technique for performing these tasks. Thus, many of the steps in this flowchart may take place simultaneously and/or in different orders than as shown. Moreover, account server 102 may use methods with additional steps, fewer steps, and/or different steps, so long as the methods remain appropriate.

Although the present invention has been described in detail, it should be understood that various changes, substitutions and alterations can be made hereto without departing from the sphere and scope of the invention as defined by the appended claims.

To aid the Patent Office, and any readers of any patent issued on this application in interpreting the claims appended hereto, applicants wish to note that they do not intend any of the appended claims to invoke ¶6 of 35 U.S.C. §112 as it exists on the date of filing hereof unless “means for” or “step for” are used in the particular claim.

What is claimed is:

1. A method for processing a long distance communication using a debit account, comprising:
receiving a deposit into a debit account, the debit account identified by an account identifier and the debit account comprising a balance;
updating a balance of the account based on the deposit;
receiving a first request for balance verification from a long distance provider in response to the long distance provider receiving an attempt to make a long distance communication using the debit account, the first request comprising a first transaction amount, a first PIN, and the account identifier;
communicating a first verification to the long distance provider, the first verification comprising the account identifier;
receiving a second request for balance verification from a debit card network provider in response to the debit card network provider receiving an attempt to withdraw funds from the debit account, the second request comprising a second transaction amount, a second PIN, and the account identifier; and
communicating a second verification to the debit card network provider, the second verification comprising the account identifier.

2. The method of claim 1, further comprising comparing the first amount with the balance and wherein communicating a first verification to the long distance provider comprises:
in response to the balance being less than the first amount, communicating a negative verification to the long distance provider; and
in response to the balance not being less than the first amount, communicating a positive verification to the long distance provider.

3. The method of claim 2, wherein the first verification further comprises a verified amount.

4. The method of claim 1 further comprising comparing the second amount with the balance and wherein communicating a second verification to the debit card network provider comprises:
in response to the balance being less than the second amount, communicating a negative verification to the debit card network provider; and
in response to the balance not being less than the requested second amount, communicating a positive verification to the debit card network provider.

5. The method of claim 1, wherein the debit card network provider comprises an automated teller machine.

6. The method of claim 1 further comprising receiving an invoice from the long distance provider, the invoice comprising the account identifier and an invoiced amount, the invoiced amount comprising a long distance rate multiplied by a number of minutes.

7. The method of claim 6 further comprising updating the balance based on the invoiced amount.

8. The method of claim 1, wherein the balance comprises an available balance and an actual balance, the method further comprising:
reducing the available balance by the first amount, the difference between the actual balance and the available balance comprising an escrow amount;
receiving an invoiced amount from the long distance provider, the invoiced amount being less than or equal to the escrow amount;
reducing the actual balance by the invoiced amount; and
adding the difference between the escrow amount and the invoiced amount to the available balance.

9. Logic for processing a long distance communication using a debit account, the logic encoded in media and operable when executed to:
receive a deposit into a debit account, the account identified by an account identifier and the account comprise a balance;
update a balance of the account based on the deposit;
receive a first request for balance verification from a long distance provider in response to the long distance provider receiving an attempt to make a long distance communication using the debit account, the first request comprising a first transaction amount, a first PIN, and the account identifier;
communicate a first verification to the long distance provider, the first verification comprise the account identifier;
receive a second request for balance verification from a debit card network provider in response to the debit card network provider receiving an attempt to withdraw funds from the debit account, the second request comprising a second transaction amount, a second PIN, and the account identifier; and
communicate a second verification to the debit card network provider, the second verification comprising the account identifier.

10. The logic of claim 9 further operable to compare the first transaction amount with the balance and wherein the logic operable to communicate a first verification to the long distance provider comprises the logic operable to:
in response to the balance being less than the first amount, communicate a negative verification to the long distance provider; and
in response to the balance not being less than the first amount, communicate a positive verification to the long distance provider.

11. The logic of claim 10, wherein the first verification further comprises a verified amount.

12. The logic of claim 9 further operable to compare the second amount with the balance and wherein the logic operable to communicate a second verification to the debit card network provider comprises the logic operable to:
in response to the balance being less than the second amount, communicate a negative verification to the debit card network provider; and
in response to the balance not being less than the second amount, communicate a positive verification to the debit card network provider.

13. The logic of claim 9, wherein the debit card network provider comprise an automated teller machine.

14. The logic of claim 9, further operable to receive an invoice from the long distance provider, the invoice comprising the account identifier and an invoiced amount, the invoiced amount comprising a long distance rate multiplied by a number of minutes.

15. The logic of claim 14 further operable to update the balance based on the invoiced amount.

16. The logic of claim 9, wherein the balance comprises an available balance and an actual balance, the logic further operable to:
reduce the available balance by the first amount, the difference between the actual balance and the available balance comprise an escrow amount;
receive an invoiced amount from the long distance provider, the invoiced amount being less than the escrow amount;
reduce the actual balance by the invoiced amount; and
add the difference between the escrow amount and the invoiced amount to the available balance.

17. A system for processing a long distance communication using a debit account, comprising:
memory operable to store at least one debit account record, wherein the account record comprise an account identifier and a balance; and
a processor operable to:
receive a deposit into a debit account, the account identified by an account identifier and the account comprise a balance, update a balance of the account based on the deposit;
update the balance in the associated account record based on the deposit;
receive a first request for balance verification from a long distance provider in response to the long distance provider receiving an attempt to make a long distance communication using the debit account, the first request comprising a first transaction amount, a first PIN, and the account identifier;
communicate a first verification to the long distance provider the first verification comprise the account identifier;
receive a second request for balance verification from a debit card network provider in response to the debit card network provider receiving an attempt to withdraw funds from the debit account, the second request comprising a second transaction amount, a second PIN, and the account identifier; and
communicate a second verification to the debit card network provider, the second verification comprising the account identifier.

18. The system of claim 17, the processor further operable to compare the first amount with the balance and wherein the processor operable to communicate a first verification to the long distance provider comprises the processor operable to:
in response to the balance being less than the first amount, the processor operable to communicate a negative verification to the long distance provider; and
in response to the balance not being less than the first amount, the processor operable to communicate a positive verification to the long distance provider.

19. The system of claim 18, wherein the first verification further comprises a verified amount.

20. The system of claim 17, the processor operable to further compare the second amount with the balance and wherein the processor operable to communicate a second verification to the debit card network provider comprises the processor operable to:
in response to the balance being less than the second amount, the processor operable to communicate a negative verification to the debit card network provider; and
in response to the balance not being less than the second amount, the processor operable to communicate a positive verification to the debit card network provider.

21. The system of claim 17, wherein the debit card network provider comprises an automated teller machine.

22. The system of claim 17, the processor further operable to receive an invoice from the long distance provider, the invoice comprise the account identifier and an invoiced amount, the invoiced amount comprise a long distance rate multiplied by a number of minutes.

23. The system of claim 22, the processor further operable to update the balance based on the invoiced amount.

24. The system of claim 17, wherein the balance comprises an available balance and an actual balance, the processor further operable to:
reduce the available balance by the first amount, the difference between the actual balance and the available balance comprise an escrow amount;
receive an invoiced amount from the long distance provider;
the invoiced amount being less than the escrow amount;
reduce the actual balance by the invoiced amount; and
add the difference between the escrow amount and the invoiced amount to the available balance.
